(19) United States
(12) Patent Application Publication
(10) Pub. No.: US 2003/0021224 A1
(43) Pub. Date: Jan. 30, 2003

(54) Broadband access control, system for protection bearers

(76) Inventor: Christopher Devitt, Draper (AU)

Correspondence Address: Nixon & Vanderhye, 8th Floor, 1100 North Glebe Road, Arlington, VA, 22201-4714, US

(21) Appl. No.: 10/221,323

(22) PCT Filed: Mar. 15, 2001
(86) PCT No.: PCT/AU01/00288

(30) Foreign Application Priority Data
Mar. 17, 2000 (AU) PQ 6357

(51) Int. Cl. H04J 1/16

(52) U.S. Cl. 370/220

(57) ABSTRACT

The invention discloses a broadband access control system having two ends with a receive and transmit switch at both ends. Main bearers and protection bearers extend between the ends. The switches operate to transmit customer data over the main bearers or over the protection bearers in the presence of a fault condition and to transmit itinerant data over the protection bearers only when the main bearers are available. A PILOT signal may be generated by the receive switches and applied to the main bearers in place of customer data and at a rate up to the rate of the customer data.

### BACKGROUND ART

Data protection switching systems currently available require the use of a communication channel from end to end to synchronise the transmission and reception switches. The communication channel can take the form of a separate channel established between the system ends or can be included in the overhead and administration area of the transmitted data.

These types of communication channels have inherent disadvantages. The separate channel model is more expensive and less robust. In the event of a communications channel failure, the protection systems will fail to operate. The separate channel must be continuously available.

The overhead method decreases the bandwidth available to the customer and requires the demodulation, data insertion and remodulation of the transmitted data. At the receive end, the stream must be demodulated, the overhead extract, the inserted data removed and restored, the overhead re-assembled and re-inserted on the customer data and delivered to the customer. The stored communication channel data must then be assembled and sent to the protection switch for processing. This means that internal clocks at both the transmit and the receive end must be synchronised to system clocks.

Generally, the communication protocol used between ends is a proprietary system and will not interwork with the protocol of another manufacturer and is usable only for digital systems.

### SUMMARY OF THE INVENTION

It is an object of the present to provide a broadband access control system which at least minimises the disadvantages referred to above. According to one aspect, the invention provides broadband access control of a system, the system having a first end and a second end, the first end having a transmit switch and a receive switch and the second end having a receive switch and a transmit switch, main bearers and protection bearers extending between the ends for transmitting customer data and itinerant data s between the ends, a respective decision circuit associated with the receive switch at the first end and with the receive switch at the second end, amplifiers associated with the receive switches and the transmit switches at the ends controllable by the decision circuits at the respective said ends, the decision circuits being responsive to an alarm insertion signal (AIS), loss of signal (LOS) data signal and a PILOT signal to control the amplifiers to provide for transmission of the customer data over either the main bearers or the protection bearers and to provide for the transmission of the itinerant data over the protection bearers only when the main bearers are available whereby when the PILOT signal is transmitted over a selected said main bearer it is transmitted at a rate up to or equal to the same rate as the customer data and in place of the customer data.

The transmit switches (or transwitch) at the first and second ends are operable for disconnecting customer data from the main bearers and for applying the PILOT signal to the main bearers in place of the customer data.

The transmit switch at the first end and the transmit switch at the second end both have two controllable amplifiers for coupling either the customer data or the itinerant data to the protection bearer. The receive switch (or transwitch) at the second end and the receive switch (or transwitch) at the first end include a controllable switch such as an operational amplifier or relay for example for either connecting the main bearers to a respective main output or for connecting the protection bearers to a respective said main output of the respective said receive switch.

A PILOT signal generator may be present in the transmit switches and the switches may include a controllable switch such as a non-latching relay for example operable by the generator for generating a PILOT signal and for applying that signal to the main bearer and to disconnect a main input for customer data from the main bearer.

The receive switches may have a controllable amplifier controlled by the decision circuit at the associated end for selectively connecting or disconnecting the protection bearer from an itinerant data output.

The system of the invention uses the entire bandwidth of the main customer channel or bearer to send inbound bearer status information back to the transmit end. This requires the insertion of specific signals, encoded to appropriate line code at line rate at the transmitter via a non-latching relay. At the receive end the inbound line code is monitored for specific words and the failure criteria using a clockless demodulation and word recognition system, The result of this monitoring process determine the content of the transmitted information.

### BRIEF DESCRIPTION OF DRAWINGS

A preferred embodiment of the invention will be described by way of example with reference to the drawings in which:

FIG. 1 is a switching timing diagram of a broadband access control system of an embodiment of the invention; and

FIG. 2 is a block diagram of a broadband access control system according to an embodiment of the invention.

### DETAILED DESCRIPTION OF THE PREFERRED EMBODIMENT

The system of the invention uses a PILOT word consisting of a data sequence “10” cyclically repeated at an appropriate data rate (such as the data rate of the customer data) and code for the communication bearers in use. The PILOT word is only transmitted if an inbound main bearer has failed with either an alarm insertion signal (AIS—a continuous stream of “1's”) or loss of signal data signal (LOS signal). If the inbound bearer is receiving a PILOT signal then the normal customer data may be transmitted. This ensures the synchronisation of the transmit and receive access to the protection bearer at each end of the system.

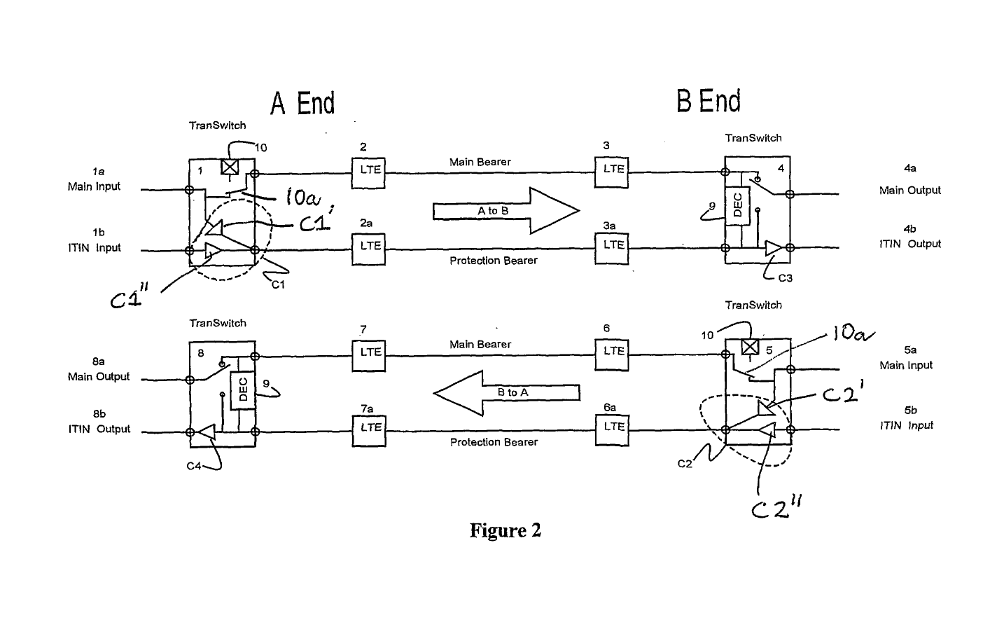

The system of an embodiment of the invention is illustrated in FIG. 2. The system has an A end and a B end. The A end has a transmit transwitch 1 and a receive transwitch 8 whilst the B end has a receive transwitch 4 and a transmit transwitch 5. Main bearers and protection bearers extend between the ends as shown. Line terminal equipment (LTE) 2, 3, 2a, 3a, 6, 6a, 7 and 7a is associated with the bearers.

Transwitch 1 has a PILOT word transmitter 10 and a PILOT word insertion switch 10a. The transwitch 1 has two amplifiers C1′ and C1″ collectively identified as C1. Amplifier C1′ extends between the main input 1a and the protection bearer whilst amplifier C1″ extends between an itinerant data input 1b and the protection bearer.

Switch 10a in transwitch I (and the identical switch 10a in transwitch 5) is a non-latching relay controlled by the PILOT word transmitter 10 for injecting a PILOT word onto the main bearer between LTE 2 and LTE 3. This injection when it occurs replaces the customer data on the main bearer and may use the entire bandwidth of the bearer. The transmission rate may be equal to or less than the data rate of the customer data.

Transwitch 4 at the B end has an amplifier C3 between the protection bearer and an itinerant data output 4b. This transwitch 4 also has a switch operable to switch the main bearer to the main output 4a or to switch the protection bearer to the main output 4a. A decision circuit 9 is present in the transwitch 4.

Transwitch 5 at the B end is identical to transwitch 1 at the A end and transwitch 8 at the A end is identical to transwitch 4 at the B end.

When the system operates and no failure of any type is present customer data is transmitted from the main input 1a along the main bearer between LTE 2 and LTE 3 and to the main output 4a. The switch in transwitch 4 is in the position shown and amplifier C3 is biased ON. Amplifier C1′ extends between input la and the protection bearer between LTE 2a and 3a is biased OFF. Amplifier of C1″ between input 1b and the protection bearer between LTE 2a and 3a is biased ON to allow itinerant data to flow from input 1b to output 4b. With the system operating in this way, main input 5a is coupled to the main bearer between LTE 6 and 7 and customer data may flow from input 5a to the main output 8a. Amplifier C4 is biased ON as is the amplifier C2″ of C2 which couples input 5b to the protection bearer between LTE 6a and 7A to allow itinerant data to flow from input 5b to output 8b. Amplifier C2′ of C2 which extends between input 5a to the protection bearer is biased OFF.

If the decision circuit 9 at end A detects the presence of either an AIS or LOS signal on the LTE 6 and 7 main bearer then itinerant data on the LTE 6a and 7a protection bearer is immediately disconnected from both input 1b in the transmit direction and in the receive direction at output 8b. At the same time, customer data is removed from the main bearer between LTE 2 and LTE 3 and a PILOT signal is transmitted from transwitch 1 at the A end to the B end via the main bearer. At this time both the amplifiers C1′ and C1″ shown at C1 and the amplifier shown at C4 are biased OFF.

The B end, the receiver transwitch 4 detects an LOS signal on the main bearer for a short period during the A end transmit relay transit time and PILOT activation time. At this time, the B end receives the PILOT signal on the main bearer. This causes the immediate removal of itinerant data from both the itinerant output at 4b and receive section itinerant input shown at 5b at the B end of the protection bearer. The presence of an AIS or LOS signal is detected on the protection bearer at both ends by the decision circuit 9 in transwitch 4 and in transwitch 8. At this time, both the amplifiers C2′ and C2″ at C2 and the amplifier C3 are biased OFF.

At the A end, approximately two seconds after transmission of the PILOT bearer on the main bearer, the customer data is connected to the protection bearer. This is accomplished by differentially biasing the amplifiers C1′ and C1″ shown at C1 such that the amplifier C1′ between input 1a and the protection bearer is biased ON and the amplifier C1″ between input 1B and the protection bearer is biased OFF. This is controlled by the decision circuit 9 at A end. At B end, data is received on the protection bearer and a switch to protection is initiated by the transwitch 4 to move the switch in the transwitch 4 from the position shown to the other position to connect the protection bearer to output 4a. At this time, amplifier C3 is still biased OFF under the control of decision circuit 9. This restores customer data from the A end to the B end. At B end approximately two seconds after the reception of the PILOT signal on the main bearer, customer data is connected to the protection bearer as well as the main bearer. This is accomplished by differentially biasing the amplifiers C2′ and C2″ shown at C2 such that the amplifier C2′ between 5a and the protection bearer is biased ON and the amplifier C2″ between 5b and the protection bearer is biased OFF. This is under the control of the decision circuit 9 at B end. At A end, data is received on the protection bearer and a switch to protection is initiated. At this time, amplifier C4 is still biased OFF under the control of the decision circuit 9 at A end. This restores data in the B to A directions.

When the main inbound bearer between LTE 6 and 7 to the A end is restored to normal, the A end decision circuit no longer detects an AIS or LOS signal. After approximately two seconds, the PILOT signal is removed and customer data is restored to the main bearer. At this time, customer data is being fed to both the main bearer and the protection bearer in both directions. If no further failures are detected then both receive transwitches are switched back to the main bearer after approximately 8 ms following restoration of data on the main bearer transmit direction. At this time both the amplifiers C1′ and C1″ at C1 and both the amplifiers C2′ and C2″ at C2 are all biased OFF.

Approximately 2 minutes later, the itinerant data is again connected at both ends in the transmit and receive directions. This is accomplished by biasing ON the amplifiers C3, C4, the amplifier C1″ at C1 which couples 1b to the protection bearer 2a/3a and the amplifier C2″ at C2 which couples 5b to protection bearer 6a/7a under the control of the decision circuits 9 at the respective ends where these amplifiers are located. The system is now normalised.

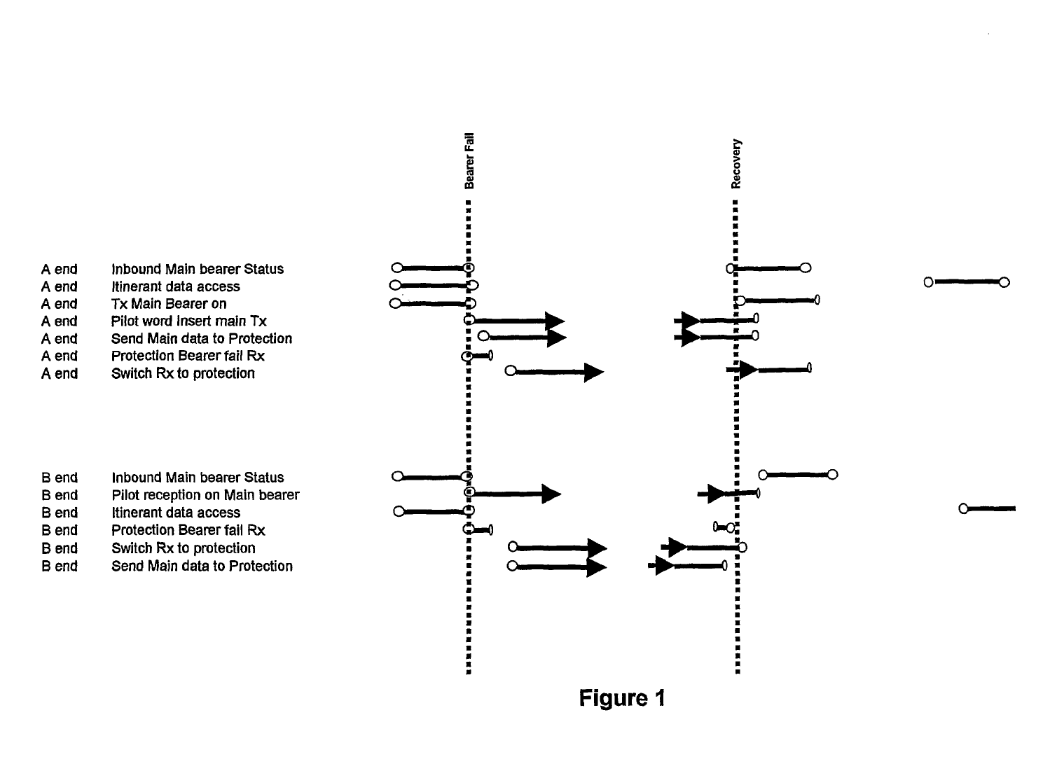

FIG. 1 is a timing diagram which summarises the operation described above.

1. Broadband access control of a system, the system having a first end and a second end, the first end having a transmit switch and a receive switch and the second end having a receive switch and a transmit switch, main bearers and protection bearers extending between the ends for transmitting customer data and itinerant data between the ends, a respective decision circuit associated with the receive switch at the first end and with the receive switch at the second end, amplifiers associated with the receive switches and the transmit switches at the ends controllable by the decision circuits at the respective said ends, the decision circuits being responsive to an alarm insertion signal (AIS), loss of signal (LOS) data signal and a PILOT signal to control the amplifiers to provide for transmission of the customer data over either the main bearers or the protection bearers and to provide for the transmission of the itinerant data over the protection bearer only when the main bearers are available whereby when the PILOT signal is transmitted over a selected said main bearer it is transmitted at a rate up to or equal to the same rate as the customer data and in place of the customer data.

2. The system of claim 1 wherein the transmit switch at the first end and the transmit switch at the second end each have a controllable switch operable for disconnecting customer data from the respective said main bearer and for applying the PILOT signal to the main bearers in place of the customer data.

3. The system of claim 2 wherein the controllable switch operable for applying the PILOT signal is a non-latching relay.

4. The system of claim 1 wherein the transmit switch at the first end and the transmit switch at the second end have two controllable amplifiers for coupling either the customer data or the itinerant data to the protection bearer.

5. The system of claim I wherein the receive switch at the second end and the receive switch at the first end include a relay controllable for either connecting the main bearers to a respective main output or for connecting the protection bearers to a respective said main output of the respective said receive switch.

6. The system of claim 3 including a pilot signal generator in the transmit switch at the first end and in the transmit switch at the second end, the PILOT generator being operable to generate a PILOT signal on the main bearer and to disconnect a main input for the customer data from the main bearer when the PILOT signal is generated by controlling the non-latching relay.

7. The system of claim 5 wherein the receive switches have a controllable amplifier controlled by the respective said decision circuit for selectively connecting or disconnecting the protection bearer from an itinerant data output.

8. The system of claim 4 wherein the respective decision circuits control the two said controllable amplifiers in the transmit switches.
